(19) United States
(12) Patent Application Publication
(10) Pub. No.: US 2009/0113793 A1
(43) Pub. Date: May 7, 2009

(54) CAPILLARY-CONTROLLED BUOYANT PLANTER

(75) Inventors: Bruce G. Kania, Shepherd, MT (US); Frank M. Stewart, Bozeman, MT (US)

Correspondence Address: ANTOINETTE M. TEASE, P. O. BOX 51016, BILLINGS, MT, 59105, US

(73) Assignee: Fountainhead, LLC, shepherd, MT (US)

(21) Appl. No.: 12/302,069

(22) PCT Filed: May 25, 2007
(86) PCT No.: PCT/US07/69704

§ 371 Date: Nov. 24, 2008

Related U.S. Application Data
(60) Provisional application No. 60/804,438, filed on Jun. 11, 2006.

(51) Int. Cl. A01G 9/02; A01G 31/02

(52) U.S. Cl. 47/65; 47/65.8

(57) ABSTRACT

A buoyant planter and its use. In one embodiment, the invention is a buoyant planter comprising: a nonwoven matrix body comprising fibers; a plurality of buoyant foam units integrated into said nonwoven matrix to produce a buoyant mass, said buoyant foam units being comprised of an expanded, cured polymer resin that envelopes a portion of said fibers to produce foamed zones; and a hydrophilic growth medium that is supported by said nonwoven matrix body. In another embodiment, the invention is a buoyant planter comprising: a nonwoven matrix body comprising fibers; a plurality of substantially vertical capillary channels within said nonwoven matrix body, each of said substantially vertical capillary channels having an upper end; and a grass sod disposed on said nonwoven matrix body and in communication with said upper ends.

### CROSS-REFERENCE TO RELATED APPLICATION

This application claims priority back to U.S. Patent Application No. 60/804,438, filed on 11 Jun. 2006.

### BACKGROUND OF THE INVENTION

The present invention relates to buoyant planters. In particular, the present invention relates to capillary-controlled buoyant planters.

In the science of agronomy, the moist, plant-growing zones of the subsurface are split into the “saturated zone” and the unsaturated or “vadose zone.” The saturated zone is the area of the subsurface that lies at or below the water table, where all of the pore spaces within the soil are filled with water. The vadose zone is the portion of the subsurface above the saturated zone that contains some water but is not saturated with water. The pore spaces between the soil particles in the vadose zone contain a combination of water and gases. Vadose zone water (or “vadose water”) is held in place by hydroscopic and capillary forces. The maximum amount of water that can be held in a particular vadose zone is a function of the particle size and shape. Excess water that enters the vadose zone (for example, from rainfall) drains by gravity through the vadose zone down to the saturated zone. Terrestrial plants have evolved to thrive in the vadose zone, as they require a growth medium in which their toots can uptake both water and air. Aquatic plants, in contrast, have evolved to thrive in the saturated zone; these plants do not need air-filled pore spaces around their roots.

The growth medium in background art buoyant planters is often too wet to grow many desirable plant species, because these products do not provide a suitable vadose zone for plant growth. In background art embodiments, water is supplied to plants within the growth medium from the pond in which the planter is floating. Water enters the planter via holes, screens, or other openings in the outer surface of the planter. With this type of watering system, the growth medium must extend downward below waterline in the pond in order to obtain moisture. The portion of the growth medium that extends below waterline becomes saturated with water. This saturated zone is suitable for sustaining aquatic plant species but is unsuitable for most terrestrial and riparian plant species, which cannot survive in water-saturated conditions unless forced aeration is provided to the roots. Conventional buoyant planters typically rely on forced aeration to support hydroponic plant growth; for example, Tepper in U.S. Pat. No. 6,086,755, describes his invention for use in “oxygenated” (i.e., aerated) water. In some cases, as plants grow taller and add negative buoyancy to the planter, the growth medium is pushed deeper into the water, resulting in progressively more saturated conditions as the plants mature. Therefore, background art floating planters are not well suited for growing tall or massive plants.

There are numerous examples of natural floating islands around the world. Some of these natural islands support a wide range of plant types. Investigations of these islands indicate that they grow aquatic plants hydroponically, with the roots growing in a water-saturated mixture of dead roots and organic material. In addition, these islands grow riparian plants (which need constant moisture but unsaturated moisture levels). Finally, these natural islands support the growth of large terrestrial plants such as pine trees that require some moisture, but they cannot tolerate saturated conditions permanently. (Lodgepole pine trees may be one exception to this rule. Lodgepole pines are common in saturated mossy bogs along the southeast coast of Alaska.)

In general, natural floating islands grow by becoming thicker over time. A mature natural floating island may have 50-year old trees that are over 50 feet tall. The islands become thicker by adding organic detritus to the top and interior of the island body. The lower edge of the island is comprised of dead material that periodically sloughs off into the water. The vertical growth pattern of these islands generally results in the island becoming thicker over time, with a corresponding thickening of the vadose zone. By this means, larger natural islands tend to support the growth of larger terrestrial plants, such as trees, that require a thicker vadose zone for their large root systems.

A natural floating island produces its thick vadose zone by constantly producing gases within the body of the island. These gases are produced by numerous types of naturally occurring bacteria and other microbes that colonize the material making up the island body. The produced gases displace water within the island body, thereby reducing its weight and producing an upward force or buoyancy. If the island body is comprised of relatively low permeability materials, the rate of gas production may equal or exceed the leak rate of gas from the island body, resulting in self-sustaining buoyancy. Terrestrial and riparian plants that prefer moist but unsaturated conditions thrive in this unsaturated zone of the island body. Aquatic plants that are adapted to saturated conditions grow roots within and through the saturated zone of the natural floating island.

The background art is characterized by U.S. Pat. Nos. 5,224,292; 5,528,856; 5,766,474; 5,980,738; 6,086,755; and 6,555,219 and U.S. Patent Application Nos. 2003/0051398; 2003/0208954; 200510183331; the disclosures of which patents and patent applications are incorporated by reference as if fully set forth herein.

### BRIEF SUMMARY OF THE INVENTION

In a preferred embodiment, the present invention is a novel buoyant planter that is configured to support the growth of a combination of aquatic, riparian, and terrestrial plants. This embodiment overcomes the narrow range of moisture levels of current floating planters by regulating and maintaining a wide range of moisture levels, thereby providing a diverse habitat suitable for various plant types. The present invention utilizes novel methods to replicate the wide range of moisture conditions that has been observed in the root-growing zones of natural floating islands.

In a preferred embodiment, the present invention is a manufactured island that eliminates the problems of overly dry or overly wet growth medium conditions by creating a relatively moist but unsaturated zone in addition to a saturated zone. The large unsaturated zone may be created by wicking water upward above the lake waterline, or by displacing water in the previously saturated zone with gases, thereby rendering it unsaturated, or by a combination of these effects. Throughout this application, the term “lake” is used to signify any body of water, including, but not limited to, a pond, river, stream, or even the ocean.

The combination of a porous matrix, capillary channels, a hydrophilic growth medium, and/or a good microbial growth habitat enable preferred embodiments of present invention to provide a relatively thick bi-vadose zone, which biomimics the relatively thick vadose zones of natural floating islands, but is not provided in conventional floating planters. The presence of both bi-vadose zones and saturated zones within preferred embodiments of the present invention provides a plant growing habitat that biomimics the wide range of growing conditions that have been observed on natural floating islands, but that is not provided in conventional floating planters.

Preferred embodiments of the present invention provide a variety of advantages. Preferred embodiments maintain a damp growth environment that is superior to the background art embodiments, which are often either too dry or too wet. Other preferred embodiments maintain a relatively constant dampness in the growth medium over a wide range of island freeboard. For example, as the plants grow upward, the island sinks deeper into the water due to the additional plant weight, but the growth medium remains above the water line, and therefore at a relatively constant level of dampness.

In preferred embodiments, the present invention provides an ideal growth environment for plants which prefer damp but unsaturated conditions. These plants, including terrestrial and riparian species, may be preferred over aquatic plants for applications where the islands are designed for special applications such as water treatment, or for special aesthetic landscaping projects.

In other preferred embodiments, the present invention is ideal for sprouting seeds that require germination at or near the top surface of the growth medium. With these embodiments, the top of the growth medium is moist; in background art embodiments, the top of the growth medium tends to be either saturated or dry.

In further preferred embodiments, the present invention provides a “safe zone” for plant root growth. The safe zone is that portion of the island matrix where roots can grow freely, but are protected from grazing by fish and other aquatic herbivores. By this means, the plants thrive even if the exposed portions of the roots beyond the edges of the island matrix) are grazed. In other words, preferred embodiments of the applicants' invention allow for plants to thrive as well as for fish to graze. By making the islands thicker, one can provide for plants, and by making it thinner one can enhance for fish grazing. In one test (conducted in Fergus Falls, Minn., in 2004), applicants found that at least two inches of matrix are required for plants to thrive in the presence of aggressively grazing fish.

The applicants have found that, in general, terrestrial plants can thrive in submerged soil as long as the saturated soil and water is well aerated, and as long as the crown of the plant, i.e., the point where roots and stem intersect, is not submerged for an extended period. However, the capillary tube, bi-vadose zone design disclosed herein eliminates any risk that plants will be exposed to either potentially adverse condition. By wicking water up to plants, the plant roots have a safe zone within the available freeboard within which appropriate interstitial spacing allows for ample aeration. Preferred embodiments protect the plant crowns from being submerged by providing significant available freeboard, in the range of seven inches, and providing the islands with adjustable levels of reserve buoyancy.

In yet other embodiments, the present invention provides for terrestrial plants in a self-watering habitat, with no external aeration requirement. This embodiment opens the door to growing a much wider variety of terrestrial plants, and their various capabilities and features, as compared to wetland plants. Because terrestrial plants outnumber aquatic plants by about nine to one, preferred embodiments of the present invention provide for much more diversity than is currently available.

In preferred embodiments, the capillary tubes of the present invention also represent planting channels. A combination of vertical and horizontal capillary channels allow for strategic planting. For instance, plants spelling out some name or promotional slogan could be readily achieved using the system disclosed herein.

To expand the mass of such an embodiment, one can again strategically use matrix trim in concert with high integrity sheets of matrix. Once impregnated with a buoyant adhesive foam, both the foam and the matrix become stronger. Essentially, preferred embodiments of the present invention give the foam an endoskeleton of recycled polyester matrix. In this way, a low-cost, high-volume, adjustably buoyant, high-surface-area island structure material is achieved. The use of trim from island construction, or scrap material from other manufacturing operations, provides a means for reusing waste polymer material that would otherwise be sent to landfills; therefore, islands that comprise trim or scrap result in a relatively low-cost product and provide beneficial environmental impacts by recycling waste material.

Preferred embodiments of the present invention may integrate an adjustably rigid coating that is optionally bondable to the top surface of the nonwoven matrix as an ultraviolet (UV) light barrier in order to protect both the nonwoven matrix and urethane foam. The coating may be colored, and it also provides an adhesive option which allows for attachment of aggregate, such as gravel or crushed walnut shells. The coating may also provide an additional barrier to impede the escape of buoyant gasses produced underneath the barrier, which provides for dynamic floating island buoyancy. The adjustably rigid coating also may function as a path or roadway for people and machines.

In preferred embodiments, manipulation of the volume of surface area within and underneath our bedding pockets allows a user to design for microbial gas production which in turn can provide self sustaining buoyancy. By manipulating the volume of surface area underneath a rigid coating, a designer can assist the islands of the present invention towards self-sustaining buoyancy while providing a UV barrier which in turn protects the polymer foam (e.g., thermosetting or thermoplastic) foam and nonwoven matrix.

The vadose zone in preferred embodiments of the current invention may be supplied by water from the top down, for example, by rainfall. In addition, the vadose zone may be supplied with water from the bottom up, via capillary action. Since this “bi-directional” water supply capability of floating islands in accordance with preferred embodiments of the present invention is different from the “top-down only” water supply in conventional agricultural vadose zones, the applicants have coined the term “bi-vadose” zone to define the unsaturated zone within the floating islands disclosed herein. The bi-vadose zone comprises the portion of the island body that is moist but not saturated; that is, the pore spaces within the bi-vadose zone of the island body contain a mixture of gases and water. For the purposes of this disclosure, the bi-vadose zone includes the area between the saturated matrix on the bottom and the normally dry matrix on the top, even though the bottom of the vadose zone may be below the level of the ambient level of the lake waterline.

The unsaturated conditions within the bi-vadose zone of preferred embodiments of the present invention are ideal for many terrestrial and riparian plant species that are desirable for use in floating planters and floating islands. In these embodiments, the moisture content of the growth medium remains relatively stable as the plants grow and island mass increases. Preferably, the growth medium pockets remain damp but above waterline for a relatively wide range of freeboard conditions on floating islands in accordance with the present invention. Because the islands can provide both aerobic and anaerobic zones within the same island body, they can be used to microbially remediate a wide range of contamination problems; for example, ammonia removal requires an aerobic environment, while nitrate removal requires an anoxic environment. Thus, an off-the-shelf island can be used to provide either aerobic or anaerobic water treatment with no modification required.

In a preferred embodiment, the invention is a buoyant planter comprising: a nonwoven matrix body comprising fibers; a plurality of buoyant foam units integrated into said nonwoven matrix to produce a buoyant mass, said buoyant foam units being comprised of an expanded, cured polymer resin that envelopes a portion of said fibers or, alternatively, is mechanically positioned within or attached to said fibers, to produce foamed zones; and a hydrophilic growth medium that is supported by said nonwoven matrix body. Preferably, said foamed zones are approximately spherical in shape. Preferably, said buoyant units are coated with a sprayed-on polymer outer covering. Preferably, said nonwoven matrix body and said hydrophilic growth medium are capable of being colonized by a microbial biofilm.

Preferably, the buoyant planter further comprises: a bi-vadose zone with said hydrophilic growth medium and/or a low permeability skin covering at least a portion of said nonwoven matrix body and/or a capillary channel within said nonwoven matrix body. Preferably, said capillary channel is selected from the group consisting of: a fully penetrating capillary tube; and a partially penetrating capillary tube. Preferably, said capillary channel contains a wicking material selected from the group consisting of: hydrophilic growth medium; hydrophilic foam; cellulose sponge; cotton; and peat. Preferably, said hydrophilic growth medium is comprised of a mixture of peat, hydrophilic foam and powdered bark.

In another preferred embodiment, the invention is a buoyant planter comprising: a nonwoven matrix body comprising fibers; a plurality of substantially vertical capillary channels within said nonwoven matrix body, each of said substantially vertical capillary channels having an upper end; and a grass sod disposed on said nonwoven matrix body and in communication with said upper ends. Preferably, each said substantially vertical capillary channel is selected from the group consisting of: a fully penetrating capillary tube; and a partially penetrating capillary tube. Preferably, each said substantially vertical capillary channel contains a wicking material selected from the group consisting of: hydrophilic growth medium; hydrophilic foam; cellulose sponge; cotton; peat; pumice and silica.

Preferably, the buoyant planter further comprises: a substantially horizontal capillary channel within said nonwoven matrix body. Preferably, said substantially horizontal capillary channel contains a wicking material selected from the group consisting of: hydrophilic growth medium; hydrophilic foam; cellulose sponge; cotton; peat; pumice and silica.

In yet another preferred embodiment, the invention is a method for growing plants in a lake comprising: providing a buoyant planter disclosed herein; planting plants in said hydrophilic growth medium to produce a buoyant island; and launching said buoyant island in the lake. Preferably, the method further comprises: exposing said hydrophilic growth medium to dissolved nitrate after said buoyant island is launched, thereby enriching denitrifying bacteria in said hydrophilic growth medium. In another embodiment, the invention is a method for growing plants in a lake comprising: providing a buoyant planter disclosed herein; and launching said buoyant island in the lake.

In a preferred embodiment, the present invention is a buoyant planter comprising: a body of nonwoven matrix fibers; a hydrophilic growth medium; and a means for providing buoyancy. In one embodiment the means for providing buoyancy is a plurality of buoyant foam units that are integrated into the body of nonwoven matrix fibers to produce a buoyant mass, and the buoyant foam units are comprised of expanded, cured polymer resin that envelopes a portion of the fibers to produce foamed zones. In an alternate embodiment, the means for providing buoyancy is microbially generated gasses. In an alternate embodiment, the means for providing buoyancy is buoyant fibers, the buoyant fibers comprise the body of nonwoven matrix fibers, and the fibers are manufactured from thermoplastic resins having specific gravities less than 1.0. In an alternate embodiment, gas bubbles are incorporated into the interior of the fibers during manufacture.

In yet another preferred embodiment, the present invention is a buoyant planter comprising: an outer shell; and an inner filling; wherein the planter comprises bottom and sides; wherein the outer shell is comprised of nonwoven matrix that covers the bottom and sides of the planter; and wherein the inner filling is comprised of hydrophilic growth medium. Preferably, water enters the planter horizontally through the sides and vertically through the bottom, and wherein the water is absorbed and wicked upward by the hydrophilic growth medium. Preferably, the planter is situated on a water body, the water body has a water level, and the water is wicked upward to a level above the water level of the water body, thereby producing a vadose zone within the planter. Preferably, the planter is situated on a water body, and the water travels radially inward through the hydrophilic growth medium due to a combination of hydrostatic pressure from the water body and the wicking action of the hydrophilic growth medium.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention.

FIG. 1 is a simplified side cross-sectional view of a natural floating island.

FIG. 2 is a schematic top plan view of a preferred embodiment of the present invention.

FIG. 3 is a schematic side cross-sectional view of a preferred embodiment of a buoyant planter, just after launching and prior to gas production.

FIG. 4 is a schematic side cross-sectional view of the buoyant planter as shown in FIG. 3, several weeks after launching.

FIG. 5 is a schematic side cross-sectional view of a second preferred embodiment of the invention.

FIG. 6 is a detailed view of a portion of the embodiment of FIG. 5 that shows upwardly moving water droplets traveling upward through a fully penetrating capillary channel and being distributed throughout the fibers of a hydrophilic growth medium.

FIG. 7 is an exploded perspective view of a third preferred embodiment of the invention.

FIG. 8 is a side cross-sectional view of FIG. 7, showing nonwoven matrix, fully penetrating capillary channels, grass sod and grass roots.

FIG. 9 is a top plan view of a fourth preferred embodiment of the invention is presented.

FIG. 10 is a schematic side cross-sectional view of the embodiment of FIG. 9, showing how fully penetrating capillary tubes are used to supply water to the horizontal capillary channels.

The following reference numerals are used to indicate the parts and environment of the invention on the drawings:
1 natural floating island
2 saturated zone
3 vadose zone
4 dry zone
5 island level of water saturation, island water level
6 lake water level, lake water line
7 vadose zone top
8 terrestrial and riparian plants
9 aquatic plants
10 nonwoven matrix, matrix
11 hydrophilic growth medium, growth medium
12 buoyant polyurethane foam units, buoyant foam units, buoyant sections of foam
13 nitrogen bubbles
14 bi-vadose zone
15 available freeboard
16 upwardly moving water droplets
17 downwardly moving water droplets
18 grass sod
19 grass roots, roots
20 horizontal capillary channels
22 buoyant planter, planter, manufactured island
24 island body
26 fully penetrating capillary tube, fully penetrating capillary channel
28 partially penetrating capillary tube, partially penetrating capillary channel
30 bottom surface
32 island surface

### DETAILED DESCRIPTION OF THE INVENTION

The buoyant planter of the present invention is comprised of a body of nonwoven matrix fibers; a hydrophilic growth medium; and a means for providing buoyancy. In one embodiment, the means for providing buoyancy is provided by a plurality of buoyant foam units integrated into said nonwoven matrix to produce a buoyant mass, said buoyant foam units being comprised of an expanded, cured polymer resin that envelopes a portion of said fibers to produce foamed zones.

In another embodiment, the means for providing buoyancy is provided by microbially generated gasses, which are produced by periphyton that colonizes the interior of the planter. The periphyton is comprised primarily of bacteria, cyanobacteria, and phytoplankton that uptake nutrients and organic carbon from the water body, and produce gases such as carbon dioxide, nitrogen and oxygen. These gases form bubbles that adhere to the submerged fibers of the matrix, thereby providing buoyant lift to the planter.

In yet another embodiment, the nonwoven fiber matrix is made from fibers that are naturally buoyant in water, and these buoyant fibers supply the means for providing buoyancy to the planter. The buoyant fibers are manufactured from thermoplastic resins having specific gravities less than 1.0. Examples of suitable thermoplastic resins include polyethylene and polyethylene. Gas bubbles may optionally be incorporated into the interior of the thermoplastic fibers during manufacture to further reduce their specific gravity, thereby increasing the buoyancy that the fibers can provide.

In yet another embodiment, the means for providing buoyancy includes a combination of two or more of the following: buoyant foam units, microbially generated gases, and buoyant fibers.

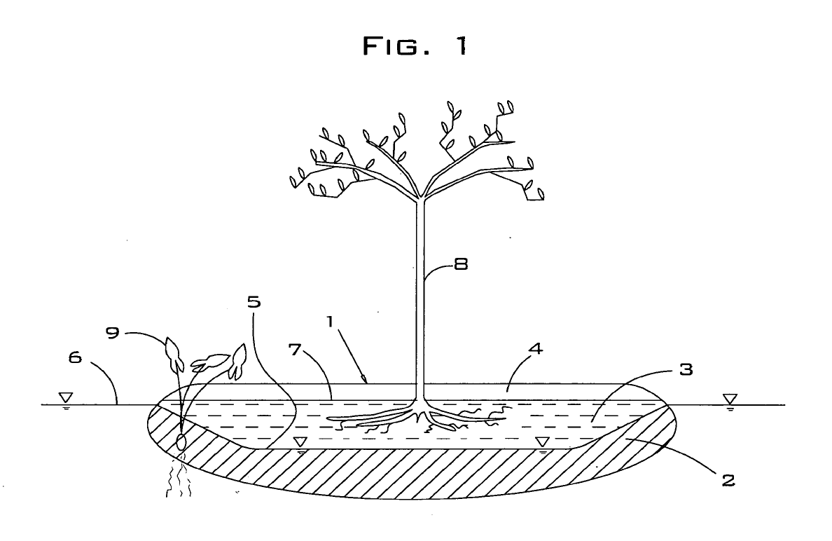

Referring to FIG. 1, a simplified side section view of a background art natural floating island is presented that schematically shows the three major moisture zones. Natural floating island 1 comprises saturated zone 2, vadose zone 3 and dry zone 4. As shown in FIG. 1, natural islands produce a relatively thick vadose zone 3, in which the level of water saturation within island body 5 is lower than take water level 6, and vadose zone top 7 is above lake waterline 6. Also shown are terrestrial and riparian (i.e., non-aquatic) plants 8 and aquatic plants 9.

In one study conducted during October 2005 on a one-acre floating island in Rainbow Flowage, Wis., the water level within the body of the island was about 33 inches below the lake waterline. In this 33-inch thick zone, the island material was moist but not saturated. A second moist but unsaturated zone existed within the island in the vadose zone above the lake waterline. This vadose zone extended about four inches above the lake waterline. The total thickness of these two moist but unsaturated zones was therefore about 33+4=37 inches at this particular location on this island, which was colonized by several species of non-aquatic plants. The edges of the island were water saturated, and were colonized with aquatic plants.

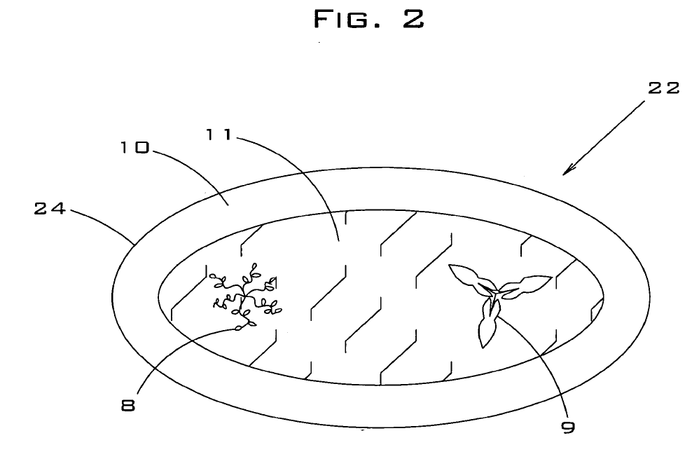

Referring to FIG. 2, a top plan view of a preferred embodiment of the present invention is presented. In this embodiment, buoyant planter or manufactured island 22 comprises island body 24 which in turn comprises nonwoven matrix 10, which supports hydrophilic growth medium 11, terrestrial or riparian plant 8 and aquatic plant 9.

In a preferred embodiment, nonwoven matrix 10 is injected with buoyant foam for flotation to produce island body 24. Preferably, zones of specialized growth medium 11 are designed to promote root growth, and optional capillary channels that transport water to the growth medium. Matrix 10 is preferably comprised of polyester fibers that are intertwined to form a randomly oriented web or “blanket” with a standard thickness and width. One manufacturer of suitable matrix material is Americo Manufacturing Company, Inc. of Acworth, Ga.

The dimensions of buoyant planter 22 are preferably established by attaching multiple pieces of matrix side-by-side and vertically to form island body 24. In one preferred embodiment, matrix 10 is comprised of 200-denier polyester fibers that are intertwined to form a blanket approximately 1¾ inch thick by 56 inches wide. Matrix 10 is preferably produced in a continuous strip and cut to lengths of approximately 90 feet for shipping. The nominal weight of the blanket is preferably 41 ounces per square yard. In a preferred embodiment, the nominal weight of the polyester fibers within the blanket is 26 ounces per square yard. A water-based latex binder is preferably baked onto the fibers to increase the stiffness and durability of the blanket. The characteristics of matrix 10 can be adjusted by varying the construction materials and manufacturing process. For example, the diameter of the fibers may be varied from approximately 6 to 300 denier. Coarse fibers result in a relatively stiff matrix with relatively small surface area for colonizing microbes, and fine fibers result in a relatively flexible matrix with a relatively large surface area for colonizing microbes.

The latex binder may be applied relatively lightly or relatively heavily to vary the durability and weight of the matrix, and dye or pigment can be added to the binder to produce a specific color of matrix. The latex-coated fibers provide an excellent growth substrate for colonization by beneficial microbes. The thickness of the blanket may be adjusted from approximately ¼-inch to 2 inches using current manufacturing techniques. It is anticipated that thicker blankets will be produced in the future, and these thicker blankets (for example, three to 12 inches thick) will be preferred when they become available.

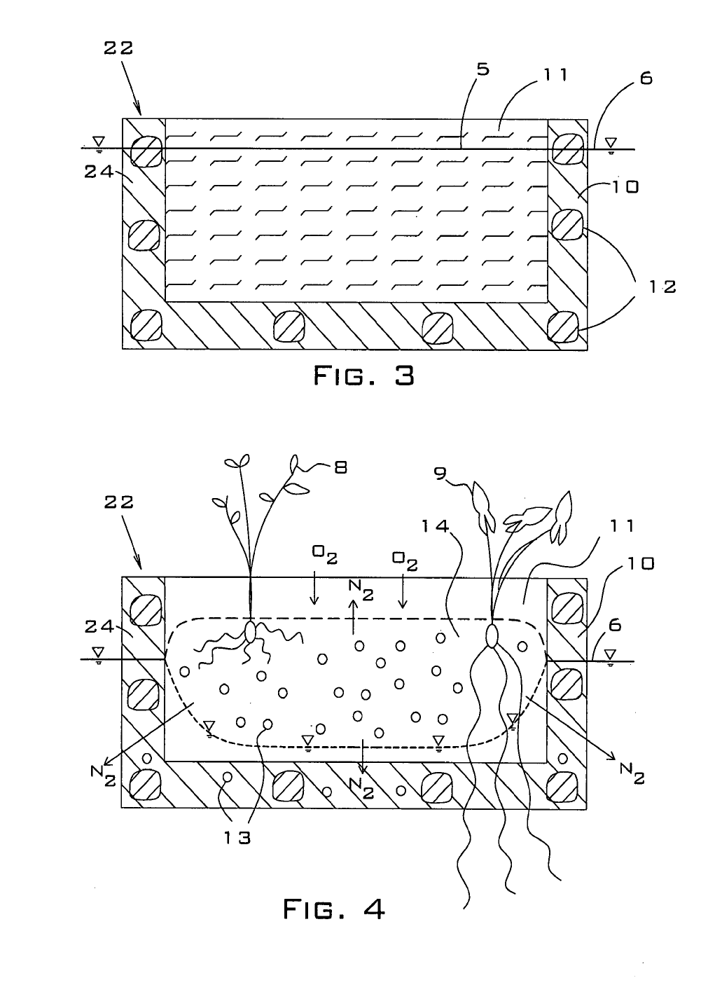

FIGS. 3 and 4 depict a first preferred embodiment of the invention, in which the bi-vadose zone extends below the waterline of the lake after the introduction of gas bubbles into the previously saturated portion of island body 24. FIG. 3 is a side cross-sectional view of this embodiment of buoyant planter 22, just after launching and prior to gas production. Buoyant planter 22 is comprised of nonwoven matrix 10, hydrophilic growth medium 11, and buoyant polyurethane foam units 12. As shown in FIG. 3, the level of level of water saturation within the island 5 is initially the same as lake water level 6.

Internal buoyancy is preferably integrated within island body 24 by injecting uncured liquid polyurethane resin under pressure into porous matrix 10. The polyurethane resin then expands and cures in place within matrix 10 to form buoyant foam units 12. The injection pressure, resin temperature, and injection shot volume of the foam injection machine are preferably selected so as to provide the desired final volume of cured buoyant foam. The foam may be installed so as to provide a continuous volume throughout matrix 10, or, alternately, it may be installed so as to provide individual buoyant sections of foam 12 within matrix 10 that are separated by non-foamed zones of matrix 10. The polyurethane resin may be injected from the top, sides, or bottom of island body 24, or from a combination of these surfaces, depending on the particular application of planter or manufactured island 22. In one preferred embodiment, matrix 10 is constructed so as to have a thickness of approximately eight inches.

Uncured foam resin having a nominal cured density of 2.5 pounds per cubic foot (pcf) is preferably injected into the bottom of matrix 10 and penetrates to the top surface of matrix 10. A four-second shot of uncured foam is preferably injected with a pressure of approximately 70 pounds per square inch, resulting in a cured mass of foam approximately spherical in shape, having a diameter of approximately eight inches. The sphere has a density of approximately 5.8 pcf, consisting of approximately 2.5 pcf polyurethane foam that is reinforced with matrix having a density of approximately 3.3 pcf. The density of the polyurethane foam may be adjusted by varying the chemical formula of the resin, or by varying the application parameters such as temperature and pressure. Practical ranges of foams for the islands preferably range from about 1.0 to 25.0 pcf. The lighter foams are desirable where high buoyancy and low cost are important, for example, for decorative water garden islands. The heavier density foams are preferable where high strength and durability are important, for example, where planter 22 may be subjected to boat impacts. Foamed units 12 within matrix 10 may be optionally coated with a spray-on polyurethane outer covering to increase durability. Alternately, self-skinning foams that cure with a tough outer cover may be used to provide extra durability.

FIG. 4 shows the same buoyant planter as shown in FIG. 3 several weeks after launching. Bi-vadose zone 14 is depicted as the zone within the dashed border inside island body 24. Bi-vadose zone 14 extends above lake water line 6 due to upward wicking of water within the growth medium 11, and it extends below lake water line 6 due to gas production. Both nonwoven matrix 10 and hydrophilic growth medium 11 are preferably fabricated from materials that are capable of being colonized by microbial biofilms. As shown, bacteria within nonwoven matrix 10 and hydrophilic growth medium 11 have produced nitrogen bubbles 13, which have displaced some water from matrix 10 and growth medium 11, thereby making planter 22 more buoyant. This increased buoyancy results in planter 22 floating higher in the water, as shown in FIG. 4. Some of the produced nitrogen bubbles 13 attach to fibers within matrix 10 and growth medium 11, and some of the nitrogen bubbles 13 escape into the atmosphere and lake, as shown by the upwardly-directed arrows. Also, since the top of the growth medium 11 is exposed to the atmosphere, oxygen and other gases pass from the atmosphere into growth medium 11 as shown by the downwardly-directed arrows.

In this embodiment, terrestrial or riparian plant 8 becomes established with its roots growing within bi-vadose zone 14, and the roots of this plant are supplied by oxygen from the atmosphere. Aquatic plant 9 also becomes established within the bi-vadose zone, but its roots preferentially grow into the saturated portion of planter 22 and into the lake. In this example, the nitrogen gas is produced by the bacterial conversion of nitrate to nitrogen gas by denitrifying bacteria, which is a well known process in wastewater treatment.

In experimental runs, the applicants have measured conversion rates of approximately 10.61 grams of nitrate and 0.5 grams of phosphate per day per square foot of island surface, using eight-inch-thick islands. In many lakes, there is sufficient nitrate dissolved in the lake water to produce adequate nitrogen gas for island buoyancy. In lakes where the nitrate concentration is not adequate, nitrate fertilizer may be applied to planter 22, where it will dissolve into island body 24 and provide nitrate to the bacteria and plant roots. Many lakes also contain naturally occurring bacteria that are capable of colonizing planter 22 and producing gas. If desired or required, supplemental microbes may be added to planter 22 to initiate or increase gas production. There are numerous commercial microbe mixtures available that are suited for this application. One example of a suitable microbe mix is AQUATRON sold by Keeton Industries of Wellington, Colo.

As buoyant planter 22 matures, algae and other organic matter collect on the outer surface of the planter. As this matter accumulates, it tends to form a low permeability “skin” around planter 22, which further slows the escape of gases from the matrix 10 and growth medium 11, resulting in an increase of planter buoyancy over time. Applicants have observed that terrestrial plants continue to thrive on planter 22 after this organic skin has formed, indicating that the rate of oxygen transfer into planter 22 remains adequate to support plant respiration. In one test with a two-inch thick planter with a top surface area of 25-square feet, the planter floated approximately ½-inch higher in the water after 6 months of aging in a freshwater pond. Significant algal accumulation was visible on the top surface of this planter.

A low-permeability skin may optionally be mechanically installed on the edges of planter 22. The skin can be formed of poly-urea, polyurethane, silicone, or any other similar low-permeability covering. The skin can optionally be used for other purposes such as a walkway or load support base, for example, a base for a wind-powered generator.

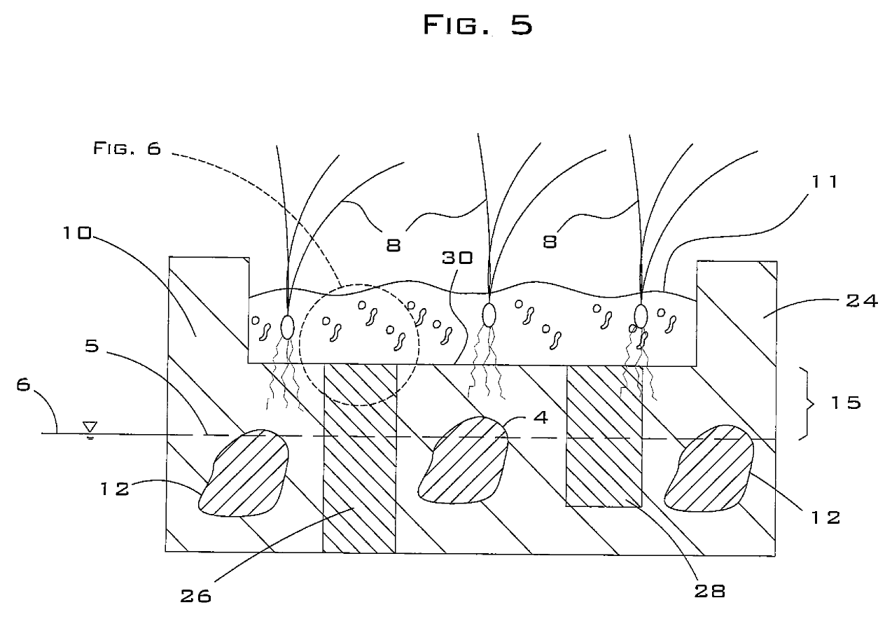

Referring to FIG. 5, a side cross-sectional view of a second preferred embodiment of the invention is presented. In this embodiment, special capillary channels 26, 28 are used to extend the bi-vadose zone of the island above the waterline of the lake. This embodiment is comprised of nonwoven matrix 10, hydrophilic growth medium 11, terrestrial and riparian plants 8, buoyant polyurethane foam units 12, fully penetrating capillary tube 26, and partially penetrating capillary tube 28. Note that the bottom surface of hydrophilic growth medium 11 is preferably situated higher than the island water level 5 within island body 24. In this embodiment, water is drawn up by capillary action through capillary tubes 26, 28 and supplied to hydrophilic growth medium 11. Because hydrophilic growth medium 11 is located above ambient lake water level 6, lake water can only enter growth medium 11 via capillary tubes 26, 28, which results in growth medium 11 remaining damp but not saturated with water. When growth medium 11 is damp but unsaturated, some of the pore spaces within growth medium 11 are filled with water, and the remainder of the pore spaces are filled with air. This unsaturated but damp environment provides an ideal growth environment for non-aquatic plants.

Capillary tubes 26, 28 may be filled with any suitable wicking material, such as hydrophilic growth medium, cellulose sponge, cotton or peat. Fully penetrating capillary tube 26 may be preferred over partially penetrating capillary tube 28 when the manufacturing and assembly costs are less for fully penetrating capillary tube 26. Partially penetrating capillary tube 28 may be preferred over fully penetrating capillary tube 26 when the material of the capillary tube tends to escape out of the bottom of an open tube. The tubes are equally effective in wicking water as long as the bottoms of the tubes are below island water level 5.

The available freeboard 15 of buoyant planter 22 is the vertical height between lake water line 6 and bottom surface 30 of growth medium 11T. As plants become taller and more massive, they add top weight to buoyant planter 22, which causes buoyant planter 22 to float deeper in the water, thereby reducing the available freeboard 15 of the buoyant planter 22. By designing the island with a relatively large initial available freeboard 15, growth medium 11 can be maintained in a moist but unsaturated condition as buoyant planter 22 gains weight and floats deeper.

Hydrophilic growth medium 11 is preferably comprised of a mixture of peat, hydrophilic foam and powdered bark. This material has the beneficial properties of being lightweight, water-wicking, good for colonization by beneficial microbes, and compatible with most plant roots.

Optional capillary channels 26, 28 are preferably formed by cutting, die stamping, or otherwise forming vertical openings within matrix 10, and packing these openings with materials that have good wicking characteristics. Peat and/or hydrophilic foam are two examples of preferred materials for use in forming capillary channels 26, 28. Hydrophilic foams may be comprised of either synthetic foam such as polyurethane, or natural materials such as cellulose. These hydrophilic foams have a portion of their pore spaces comprised of open cells that soak up and transfer water, and the remainder of the pore spaces comprised of closed cells that do not absorb water. This combination of open and closed cells results in a material that wicks water while at the same time remaining relatively lightweight. Experiments have shown that a wicking height of seven inches can be obtained in capillary channels 26, 28 that are filled with a mixture of peat and hydrophilic polyurethane foam.

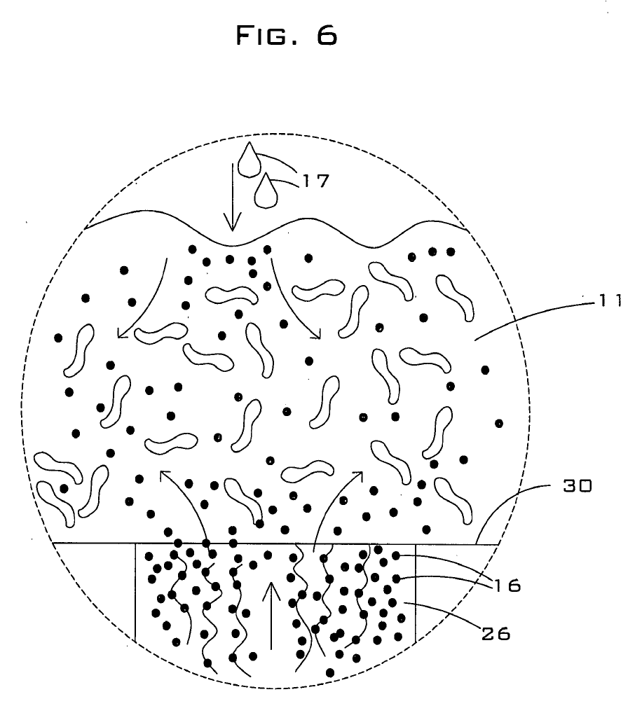

Referring to FIG. 6, a detailed view of a portion of FIG. 5 is presented that shows upwardly moving water droplets 16 traveling upward through fully penetrating capillary channel 26 and being distributed throughout the fibers of hydrophilic growth medium 11. Also shown are downwardly moving water droplets 17 that are being supplied to growth medium 11 by rainfall. Water droplets 16, 17 spread laterally through growth medium 11 after they enter it, as shown by the curved arrows. Because the entire volume of growth medium 11 in this figure contains some water, but is less than saturated, this volume of growth medium 11 can be described as being completely within the bi-vadose zone.

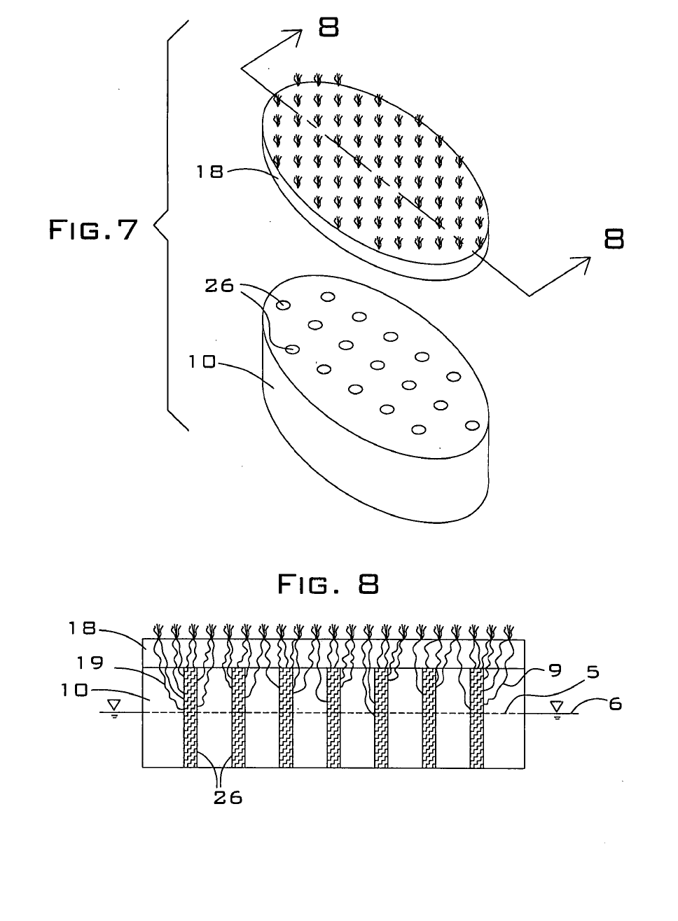

Referring to FIG. 7, an exploded perspective view of a third preferred embodiment of the invention is presented. This embodiment comprises nonwoven matrix 10, fully penetrating capillary channels 26 and grass sod 18. FIG. 8 is a side cross-sectional view of FIG. 7, showing nonwoven matrix 10, fully penetrating capillary channels 26, grass sod 18, and grass roots 19. As shown in FIG. 8, grass roots 19 preferentially grow toward and into capillary channels 26. This natural ability of roots 19 to grow toward water, in combination with the presence of capillary channels 26 distributed through nonwoven matrix 10, provides a means for starting and sustaining grass sod 18 at an elevation above natural island water level 5. The applicants have determined in experimental trials that grass sod will thrive seven inches above lake water line 6 when capillary tubes 26 occupy about ten percent of the internal volume of nonwoven matrix 10.

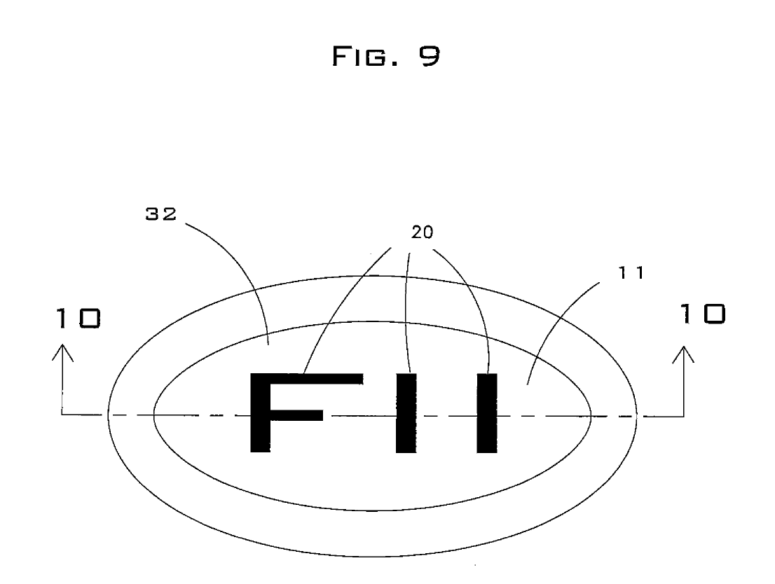

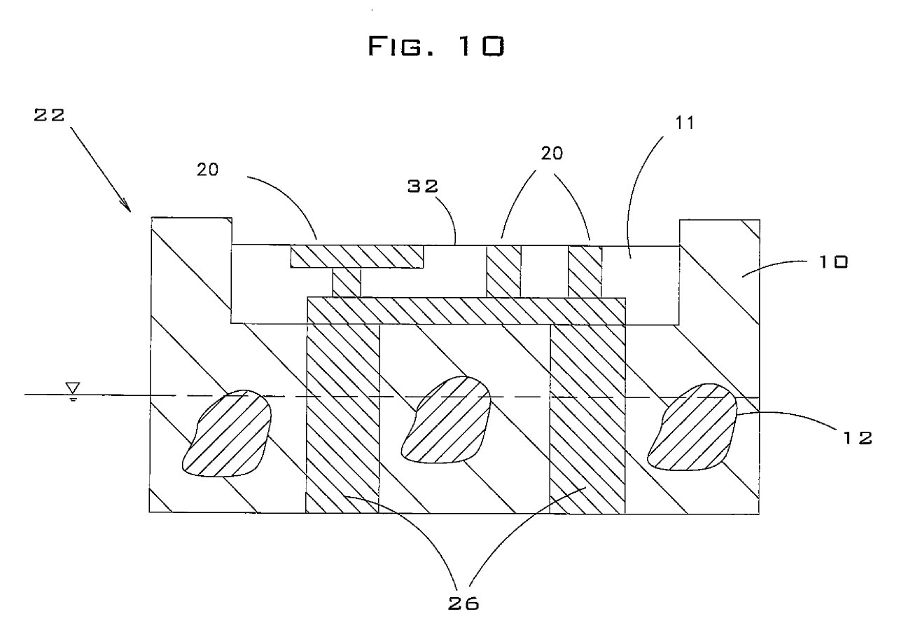

Referring to FIG. 9, a top plan view of a forth preferred embodiment of the invention is presented. In this embodiment, horizontal capillary channels 20 are used to construct a pattern on island surface 32, Horizontal capillary channels 20 are capable of supporting plant growth, and may be planted with different varieties of plants than are planted in growth medium 11, thereby creating a pattern comprised of living plants. In this example, the pattern represents the letters “FII”, which is a company logo. FIG. 10 is a side cross-sectional view of the embodiment of FIG. 9, showing how fully penetrating capillary tubes 26 are used to supply water to horizontal capillary channels 20. Horizontal capillary channels 20 may be manufactured so as to have a color that contrasts with the color of growth medium 11, thereby providing an initial contrasting color pattern prior to plants becoming established in horizontal capillary channels 20 and growth medium 11.

In yet another embodiment the planter is comprised of: an outer shell comprised of nonwoven matrix that covers the bottom and sides of the planter; and an inner filling comprised of hydrophilic growth medium. The outer shell acts to contain the hydrophilic growth medium, thereby preventing it from breaking apart and escaping into the water body. The outer shell, being permeable, also provides a means for water to enter into the interior portion of the planter and come into contact with the hydrophilic growth medium. In this embodiment, water can enter horizontally into the planter through the sides, as well as vertically through the bottom. After the water penetrates the outer shell, it is absorbed by the hydrophilic growth medium, and wicked upward by the hydrophilic properties of the growth medium. The water will eventually be wicked vertically to a level above the normal water level of the water body, thereby producing a vadose zone within the planter. At the same time, the water will travel radially inward through the hydrophilic growth medium due to a combination of hydrostatic pressure from the water body and wicking action of the growth medium.

Any of the various mechanisms described in the above embodiments may be combined within a single manufactured island 22 to further enlarge the bi-vadose zone of the island. Many other variations of the invention will occur to those skilled in the art. Some variations include horizontal and/or vertical capillary tubes. Other variations call for incorporation of buoyant foam units and/or hydrophilic growth medium. All such variations are intended to be within the scope and spirit of the invention.

Although some embodiments are shown to include certain features, the applicants specifically contemplate that any feature disclosed herein may be used together or in combination with any other feature on any embodiment of the invention. It is also contemplated that any feature may be specifically excluded from any embodiment of the invention.

What is claimed is:

1. A buoyant planter comprising:
a nonwoven matrix body comprising fibers;
a plurality of buoyant foam units integrated into said nonwoven matrix to produce a buoyant mass, said buoyant foam units being comprised of an expanded, cured polymer resin that envelopes a portion of said fibers to produce foamed zones; and
a hydrophilic growth medium that is supported by said nonwoven matrix body.

2. A buoyant planter comprising:
a nonwoven matrix body comprising fibers;
a plurality of buoyant foam units integrated into said nonwoven matrix to produce a buoyant mass, said buoyant foam units being comprised of an expanded, cured polymer resin that is mechanically bonded within or onto said fibers to produce foamed zones; and
a hydrophilic growth medium that is supported by said nonwoven matrix body.

3. The buoyant planter of claim 1 wherein said foamed zones are approximately spherical in shape.

4. The buoyant plant habitat of claim 1 wherein said buoyant units are coated with a sprayed-on polymer outer covering.

5. The buoyant planter of claim 1 wherein said nonwoven matrix body and said hydrophilic growth medium are capable of being colonized by a microbial biofilm.

6. The buoyant planter of claim 1 further comprising:
a bi-vadose zone with said hydrophilic growth medium.

7. The buoyant planter habitat of claim 1 further comprising:
a low permeability skin covering at least a portion of said nonwoven matrix body.

8. The buoyant plant habitat of claim 1 further comprising:
a capillary channel within said nonwoven matrix body.

9. The buoyant planter of claim 8 wherein said capillary channel is selected from the group consisting of:
a fully penetrating capillary tube; and
a partially penetrating capillary tube.

10. The buoyant planter of claim 8 wherein said capillary channel contains a wicking material selected from the group consisting of:
hydrophilic growth medium;
hydrophilic foam;
cellulose sponge;
cotton;
peat;
pumice; and
silica.

11. The buoyant planter of claim 1 wherein said hydrophilic growth medium is comprised of a mixture of peat, hydrophilic foam and powdered bark.

12. A buoyant planter comprising:
a nonwoven matrix body comprising fibers;
a plurality of substantially vertical capillary channels within said nonwoven matrix body, each of said substantially vertical capillary channels having an upper end; and
a grass sod disposed on said nonwoven matrix body and in communication with said upper ends.

13. The buoyant planter of claim 12 wherein each said substantially vertical capillary channel is selected from the group consisting of:
a fully penetrating capillary tube; and
a partially penetrating capillary tube.

14. The buoyant planter of claim 12 wherein each said substantially vertical capillary channel contains a wicking material selected from the group consisting of:
hydrophilic growth medium;
hydrophilic foam;
cellulose sponge;
cotton;
peat;
pumice; and
silica.

15. The buoyant planter of claim 12 further comprising:
a substantially horizontal capillary channel within said nonwoven matrix body.

16. The buoyant planter of claim 15 wherein said substantially horizontal capillary channel contains a wicking material selected from the group consisting of:
hydrophilic growth medium;
hydrophilic foam;
cellulose sponge;
cotton;
peat;
pumice; and
silica.

17. A method for growing plants in a lake comprising:
providing the buoyant planter of claim 1;
planting plants in said hydrophilic growth medium to produce a buoyant island; and
launching said buoyant island in the lake.

18. The method claim 17 further comprising:
exposing said hydrophilic growth medium to dissolved nitrate after said buoyant island is launched, thereby enriching denitrifying bacteria in said hydrophilic growth medium.

19. A method for growing plants in a lake comprising:
a step for providing the buoyant planter of claim 1;
a step for planting plants in said hydrophilic growth medium to produce a buoyant island; and
a step for launching said buoyant island in the lake.

20. A method for growing plants in a lake comprising:
providing the buoyant planter of claim 1 or 12; and
launching said buoyant island in the lake.

21. A method for growing plants in a lake comprising:
a step for providing the buoyant planter of claim 1 or 12; and
a step for launching said buoyant island in the lake.

22. A buoyant planter comprising:
(a) a body of nonwoven matrix fibers;
(b) a hydrophilic growth medium; and
(c) a means for providing buoyancy.

23. The buoyant planter of claim 22, wherein the means for providing buoyancy is a plurality of buoyant foam units that are integrated into the body of nonwoven matrix fibers to produce a buoyant mass, and wherein the buoyant foam units are comprised of expanded, cured polymer resin that envelopes a portion of the fibers to produce foamed zones.

24. The buoyant planter of claim 22, wherein the means for providing buoyancy is microbially generated gasses.

25. The buoyant planter of claim 22, wherein the means for providing buoyancy is buoyant fibers, wherein the buoyant fibers comprise the body of nonwoven matrix fibers, and wherein the fibers are manufactured from thermoplastic resins having specific gravities less than 1.0.

26. The buoyant planter of claim 25, wherein gas bubbles are incorporated into the interior of the fibers during manufacture.

27. A buoyant planter comprising:
(a) an outer shell; and
(b) an inner filling;
wherein the planter comprises bottom and sides;
wherein the outer shell is comprised of nonwoven matrix that covers the bottom and sides of the planter; and
wherein the inner filling is comprised of hydrophilic growth medium.

28. The buoyant planter of claim 27, wherein water enters the planter horizontally through the sides and vertically through the bottom, and wherein the water is absorbed and wicked upward by the hydrophilic growth medium.

29. The buoyant planter of claim 28, wherein the planter is situated on a water body, wherein the water body has a water level, and wherein the water is wicked upward to a level above the water level of the water body, thereby producing a vadose zone within the planter.

30. The buoyant planter of claim 28, wherein the planter is situated on a water body, and wherein the water travels radially inward through the hydrophilic growth medium due to a combination of hydrostatic pressure from the water body and the wicking action of the hydrophilic growth medium.
